(19) United States
(12) Patent Application Publication
(10) Pub. No.: US 2008/0212694 A1
(43) Pub. Date: Sep. 4, 2008

(54) Signal decoding systems

(75) Inventors: Martin Geoffrey Leach, Cambridge (GB); Peter Anthony Borowski, Cambridge (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: Artimi, Inc., Santa Clara, CA (US)

(21) Appl. No.: 11/715,363

(22) Filed: Mar. 8, 2007

(30) Foreign Application Priority Data
Mar. 1, 2007 (GB) 0703969.6

(51) Int. Cl. H04L 27/28

(52) U.S. Cl. 375/260

(57) ABSTRACT

We describe a method of decoding a DCM (dual carrier modulation) modulated OFDM signal, the method comprising: inputting first received signal data representing modulation of a multibit data symbol onto a first carrier of said OFDM signal using a first constellation; inputting second received signal data representing modulation of said multibit data symbol onto a second, different carrier of said OFDM signal using a second, different constellation; determining a combined representation of said first and second received signal data, said combined representation representing a combination of a distance of a point representing a bit value of said multibit data from a constellation point in each of said different constellations; and determining a decoded value of a data bit of said multibit data using said combined representation.

### BACKGROUND OF THE INVENTION

1. Field of the Invention

This invention relates to methods, apparatus and computer program code for decoding OFDM (orthogonal frequency division multiplexed) signals, in particular DCM (dual carrier modulation) modulated OFDM signals such as those used for UWB (ultra wideband) communications systems.

2. Background Art

The MultiBand OFDM (orthogonal frequency division multiplexed) Alliance (MBOA), more particularly the WiMedia Alliance, has published a standard for a UWB physical layer (PHY) for a wireless personal area network (PAN) supporting data rates of up to 480 Mbps. This document was published as, “MultiBand OFDM Physical Layer Specification”, release 1.1, Jul. 14, 2005; release 1.2 is now also available. The skilled person in the field will be familiar with the contents of this document, which are not reproduced here for conciseness. However, reference may be made to this document to assist in understanding embodiments of the invention. Further background material may be found in Standards ECMA-368 & ECMA-369.

Broadly speaking a number of band groups are defined, one at around 3 GHz, a second at around 6 GHz, each comprising three bands; the system employs frequency hopping between these bands in order to reduce the transmit power in any particular band.

The OFDM scheme employs 112-122 sub-carriers including 100 data carriers (a total FFT size of 128 carriers) which, at the fastest encoded rate, carry 200 bits using DCM (dual carrier modulation). A ¾ rate Viterbi code results in a maximum data under the current version of this specification of 480 Mbps.

Broadly speaking, in DCM two carriers are employed each using points of a 16 QAM (quadrature amplitude modulation) constellation, but only sixteen combinations of the points are used to encode data—that is, there are only certain allowed combinations of the constellation points on the two carriers.

Details of the UWB DCM modulation scheme can be found in the “MultiBand OFDM physical layer specification” (ibid), in particular at section 6.9.2, which section is hereby incorporated by reference into the present specification.

In detail, a group of two hundred coded and interleaved binary data bits is converted into one hundred complex numbers by grouping the two hundred coded bits into fifty groups of 4 bits each.

Each group is represented as (b[g(k)], b[g(k)+1], b[g(k)+50], b[g(k)+51]), where k ε[0,49] and

$$g ( k ) = \{ \begin{matrix}2 k & k ∈ [ 0 , 24 ] \\ 2 k + 50 & k ∈ [ 25 , 49 ]\end{matrix}$$

Each group of 4 bits is mapped onto a four-dimensional constellation and converted into two complex numbers, d[k] and d[k+50], using the mapping shown in FIG. 1a. The complex numbers are normalised using a normalisation factor of 1/√10. The constellations shown in FIG. 1a can also be expressed using the table below:

| | d[k] | d[k] | d[k]+50 | d[k]+50 |
|---|---|---|---|---|
| Input Bits | I-out | Q-out | I-out | Q-out |
| 0000 | −3 | −3 | 1 | 1 |
| 0001 | −3 | −1 | 1 | −3 |
| 0010 | −3 | 1 | 1 | 3 |
| 0011 | −3 | 3 | 1 | −1 |
| 0100 | −1 | −3 | −3 | 1 |
| 0101 | −1 | −1 | −3 | −3 |
| 0110 | −1 | 1 | −3 | 3 |
| 0111 | −1 | 3 | −3 | −1 |
| 1000 | 1 | −3 | 3 | 1 |
| 1001 | 1 | −1 | 3 | −3 |
| 1010 | 1 | 1 | 3 | 3 |
| 1011 | 1 | 3 | 3 | −1 |
| 1100 | 3 | −3 | −1 | 1 |
| 1101 | 3 | −1 | −1 | −3 |
| 1110 | 3 | 1 | −1 | 3 |
| 1111 | 3 | 3 | −1 | −1 |

One approach to decoding DCM modulated data would be to determine the distance of an equalised received signal value from the nearest constellation point in each constellation and then to take the minimum. However the inventors have recognised that this approach can be improved upon.

### SUMMARY OF THE INVENTION

According to a first aspect of the invention there is therefore provided a method of decoding a DCM (dual carrier modulation) modulated OFDM signal, the method comprising: inputting first received signal data representing modulation of a multibit data symbol onto a first carrier of said OFDM signal using a first constellation; inputting second received signal data representing modulation of said multibit data symbol onto a second, different carrier of said OFDM signal using a second, different constellation; determining a combined representation of said first and second received signal data, said combined representation representing a combination of a distance of a point representing a bit value of said multibit data from a constellation point in each of said different constellations; and determining a decoded value of a data bit of said multibit data using said combined representation.

In embodiments of the method, employing a combined distance representation enables the two different constellations on the different OFDM carriers to be jointly decoded, thus providing a significant improvement in performance. Broadly speaking in embodiments the combined distance is a sum of distances in the different first and second constellations; in embodiments this is used to determine a soft, more particularly log likelihood ratio (LLR) value of a decoded data bit.

Thus in preferred embodiments first and second binary values of the bit, for example 1 and 0, are considered and for each binary value a summed distance is determined representing a distance of a received signal for the bit to corresponding correlation points in the different constellations. More particularly a set of such summed distances is determined and the minimum summed distance is selected. The difference between the two minimum summed distances for the two different bit values is then used to determine the log likelihood ratio for the bit.

Corresponding constellation points in the two different constellations comprise points representing the same symbol in the two different constellations, but in preferred embodiments the distance comprises a one-dimensional distance in the I or Q (real or imaginary) direction since a full Euclidean distance need not be determined. This can be understood by inspection of FIG. 1a. Consider, for example, the symbol point for 0110. This can be found in the second column of the upper constellation and the first column of the lower constellation, but in each case each entry in each of the columns has a zero in the first bit position and therefore, in this example, only the distance along the I axis need be determined. This simplifies the distance determination.

Further, although embodiments of the method determine combined distance data representing a sum of distances as described above, in some preferred embodiments this is not done by determining a point on the constellation representing a value of the received signal. The inventors have recognised that the calculation can be further simplified by, counter-intuitively, combining the mathematics involved in equalisation and demodulation without explicitly deriving a value which would correspond to an equalised received signal value (and hence which could be plotted on a constellation diagram). Instead a combination of a received signal value and a channel estimate is employed in distance determination but without dividing the received signal by the channel estimate.

Thus in a related aspect the invention provides a method of decoding an OFDM signal, the method comprising: inputting a complex received signal value for a carrier of said OFDM signal; inputting a complex channel estimate for said carrier; determining an intermediate signal value comprising a product of said received signal value and a complex conjugate of said channel estimate and decoding said UWB OFDM signal using said intermediate signal value.

The intermediate signal value may or may not take into account noise. Preferably the decoding comprises calculating an LLR for a data bit represented by the received signal value using the intermediate signal value, but without dividing by the channel estimate to obtain data which can, in effect, be plotted on the constellation diagram to determine a distance metric such as a Euclidean distance metric.

Preferably, although not essentially, the intermediate signal value is scaled (weighted) by an estimated noise level. In this way the apparent noise floor can be taken into account in order to weight the received signal data according to the noise level and hence improve confidence in the (soft) decoded bit value. Potentially at this decoding stage the noise per carrier could be taken into account although in embodiments an overall or average noise level is estimated (but see also below).

In embodiments the estimated noise level comprises a component of estimated noise, more particularly a thermal noise component, which may be derived from an AGC (automatic gain control) loop of the receiver. However in a receiver with an ADC (analogue-to-digital converter) prior to the demodulation quantisation noise can also be significant. This is particularly the case in a very high speed receiver such as a UWB receiver where because the ADC must be very fast the resolution tends to be limited (for example in a later described embodiment of a UWB receiver the ADC has a resolution of approximately 5.5 bits). If the AGC loop gain is high then thermal noise tends to dominate but if the gain is low the quantisation noise becomes more important and may dominate the thermal noise. This, again is counter-intuitive since the effect in practice is that the overall bit or packet error rate can increase as the received signal-to-noise ratio improves above a threshold point. Therefore, in some preferred embodiments, the estimated noise level includes a noise component representing an estimate of a quantisation noise in the receiver. This may comprise, for example, a value from a register for a predetermined or fixed value.

In embodiments the scaling mathematically involves dividing by an estimated noise level but in some preferred implementations the estimated noise level is used as an index to a location in a look up table which outputs a value which can be used to multiply by to scale by the estimated noise level. The estimated noise level may be heavily quantised and may be represented in dB, for example over a range of approximately 50 dB. In one embodiment the lookup table is combined with a shift register to further reduce the storage requirements, in embodiments allowing a four entry lookup table to provide sixteen output values (effectively providing a log scale). Broadly speaking in embodiments scaling by the estimated noise level effectively limits the dynamic range which the decoder should be able to handle.

Where, as described above, a summed distance (in one dimension) is determined using intermediate data values (rather than explicitly equalising received signal data) in particular, in a linear combination, preferably one or more terms representing a signal level or signal-to-noise ratio for the pair of DCM carriers are also included in the calculation.

The above described technique employing intermediate signal values rather than explicitly dividing by a channel estimate is not restricted to DCM modulation and may also be employed, for example, for QPSK (quadrature phase shift keying). More particularly embodiments of a UWB QPSK modulation scheme modulate the same data across four separate OFDM carriers. A decoded bit LLR value may be determined from a linear combination of the above mentioned intermediate signal values for each of the carriers, again simplifying the decoding.

In another aspect the invention provides a method of determining a bit log likelihood ratio, LLR for a DCM (dual carrier modulation) modulated OFDM signal, the method comprising calculating a value for

$$LLR ( {b}_{n} ) = {min}_{{x}_{j} ∈ S 0} ( {ρ}_{1} {‖ {r}_{1} - {x}_{j}^{1} ‖}^{2} + {ρ}_{2} {‖ {r}_{2} - {x}_{j}^{2} ‖}^{2} ) - {min}_{{x}_{i} ∈ S 1} ( {ρ}_{1} {‖ {r}_{1} - {x}_{i}^{1} ‖}^{2} + {ρ}_{2} {‖ {r}_{2} - {x}_{i}^{2} ‖}^{2} )$$

where xⱼεS0 represents a set of DCM constellation points for which bₙ has a first binary value and xᵢεS1 represents a set of DCM constellation points for which bₙ has a second, different binary value; xⱼ¹ and xⱼ² and xᵢ¹ and xᵢ² represent constellation points for xⱼ and xᵢ in different first and second constellations of said DCM modulation respectively, the superscripts labelling constellations; ρ₁ and ρ₂ representing signal levels or signal-to-noise ratios of first and second OFDM carriers modulated using said first and second constellations respectively; r₁ and r₂ representing equalised received signal values from said first and second OFDM carriers respectively, and min ( ) representing determining a minimum value.

Preferably ∥·∥² represents a squared Euclidean distance metric (weighted by ρ in the above equation), that is an L² norm is employed, although other (squared) distance metrics (e.g. an L₁, Lₙ or L∞ norm) may alternatively be used. Preferably the determining of a minimum value comprises (independently) determining a minimum value of one or both of

αρ₁ [symbol] (r₁)+βρ₂ [symbol] (r₂)+γρ₁+δρ₂

and

α′ρ₁ [symbol] (r₁)+β′ρ₂ [symbol] (r₂)+γ′ρ₁+δ′₂

where [symbol] and [symbol] denote taking real and imaginary components respectively.

Preferably the determining employs intermediate signal value as described above. Thus preferably the determining of ρ₁ [symbol] (r₁), ρ₂ [symbol] (r₂), ρ₁ [symbol] (r₁) and ρ₂ [symbol] (r₂ ) comprises, respectively, determining [symbol] (y₁h₁*), [symbol] (y₂h₂*), [symbol] (y₁h₁*) and [symbol] (y₂h₂*) where y₁, and y₂ are received signal values from the first and second OFDM carriers respectively, h₁ and h₂ are channel estimates for the first and second OFDM carriers respectively, and * denotes the complex conjugate. In embodiments where p represents signal-to-noise ratio, scaling (dividing) by noise (σ²) may be made before or after determining the real and imaginary components (for example,

$$\frac{ℜ ( {yh}^{*} )}{{σ}^{2}} or ℜ ( \frac{{yh}^{*}}{{σ}^{2}} ) ) .$$

The invention also provides an OFDM DCM decoder for decoding at least one bit value from a DCM OFDM signal, the decoder comprising: a first input to receive a first signal dependent on a product of a received signal from a first carrier of said DCM OFDM signal and a channel estimate for said first carrier; a second input to receive a second signal dependent on a product of a received signal from a second carrier of said DCM OFDM signal and a channel estimate for said second carrier; an arithmetic unit coupled to said first and second inputs and configured to form a plurality of joint distance metric terms including a first pair of joint distance metric terms derived from both said first and second signals and a second pair of joint distance metric terms derived from both said first and second signals, said first pair of joint distance metric terms corresponding to a first binary value of said bit value for decoding, said second pair of joint distance metric terms corresponding to a second binary value of said bit value for decoding; a first selector coupled to receive said first pair of joint distance metric terms as inputs and to select one of said first pair of joint distance metric terms having a minimum value; a second selector coupled to receive said second pair of joint distance metric terms as inputs and to select one of said second pair of joint distance metric terms having a minimum value; and an output coupled to said first and second selectors and configured to output a likelihood value defining a likelihood of said at least one bit value having either said first or said second binary value responsive to a difference between said selected one of said first pair of joint distance metric terms and said selected one of said second pair of joint distance metric terms.

The skilled person will understand that embodiments of the above decoder may be implemented in either hardware, or software, or a combination of the two. Elements of the decoder, for example elements of the arithmetic unit and/or the first or second selector may be multiplexed or otherwise time-shared.

In preferred embodiments the decoder includes third and fourth inputs coupled to the arithmetic unit to receive signal level or SNR data for the first and second carriers respectively. In embodiments, in particular for UWB DCM decoding, third and fourth selectors are provided, and configured to output likelihood value data for a second bit of a DCM encoded symbol.

Embodiments of a decoder as described above may be used repeatedly or in parallel to decode a first bit or pair of bits from real first and second signal inputs (or real components of the inputs) and the second bit or pair of bits from imaginary first and second signal inputs (or imaginary components of these inputs).

In embodiments one or each decoded bit value may be employed, following a hard decision on the bit, to select one of the inputs to selectors to provide an output comprising a minimum distance metric term associated with the bit; this may be used later, for example in Viterbi decoding or to calculate an effective SNR for the jointly decoded DCM OFDM carriers. Thus in embodiments the decoder may also include an SNR calculation unit to determine an SNR using such a minimum distance metric term.

The signal level or SNR of each carrier of the OFDM signal or an effective joint SNR for a pair of carriers for a DCM OFDM signal may be employed by a subsequent iteration of the decoding for improved performance.

Thus in a further aspect the invention provides a method of decoding a received OFDM signal, the method comprising: decoding bit log likelihood ratio (LLR) data from a plurality of carriers of said OFDM signal responsive to a received signal strength or signal-to-noise ratio of said received OFDM signal; determining signal strength or signal-to-noise ratio data for individual carriers or pairs of carriers of said OFDM signal using said LLR data; and feeding back said signal strength or signal-to-noise ratio data for individual carriers or pairs of carriers of said OFDM signal to said decoding of said bit LLR data to improve said LLR data.

In embodiments, if a particular carrier is noisy the weight of the information carried by the carrier may be reduced, in effect re-basing the carriers to a substantially level noise floor. The information on the noise level associated with a carrier may be derived from the output of the LLR decoder, in the case of a DCM modulated OFDM signal being determined from a DCM joint carrier pair (using a minimum distance metric based upon a hard bit decision). Additionally or alternatively the noise level or SNR may be dependent upon a level of quantisation of system noise for the receiver, for example as described above.

The signal strength/SNR data for each carrier/carrier pair may be determined from, say, the header portion of a frame and then used to determine improved LLR data when decoding the generally higher data rate payload, which is more susceptible to the effects of noise. Preferably the feedback loop is reset at intervals (as it would be by basing the noise estimate on, say, the first few symbols of a frame) in order to reduce the risk of the feedback loop becoming trapped by historical data.

In a further aspect the invention provides a method of decoding an OFDM signal in a digital receiver system, the method comprising: inputting a complex received signal value (yᵢ) for a carrier of said OFDM signal, said received signal value being derived from analogue-to-digital conversion of a received signal; inputting first and second components of estimated noise for said received signal value, one of said components of estimated noise representing quantisation noise from said analogue-to-digital conversion; summing said first and second estimated noise components to determine a combined estimated noise for said received signal data; and determining likelihood data for a data bit represented by said received signal value wherein said likelihood data is dependent on said combined estimated noise.

Optionally a contribution to the combined estimated noise from an interferer may also be taken into account (as it may also be in the other embodiments described above). An estimate of the level of interference may also be determined for example by listening in a “silent” period.

The invention further provides a decoder including means to implement a method as described above in accordance with an aspect or embodiment of an aspect of the invention.

The invention still further provides processor control code to implement the above-described protocols and methods, in particular on a carrier such as a disk, CD- or DVD-ROM, programmed memory such as read-only memory (Firmware), or on a data carrier such as an optical or electrical signal carrier. Code (and/or data) to implement embodiments of the invention preferably comprises code for a hardware description language such as Verilog (Trade Mark) or VHDL (Very high speed integrated circuit Hardware Description Language) or SystemC, although it may also comprise source, object or executable code in a conventional programming language (interpreted or compiled) such as C, or assembly code, or code for setting up or controlling an ASIC (Application Specific Integrated Circuit) or FPGA (Field Programmable Gate Array). As the skilled person will appreciate such code and/or data may be distributed between a plurality of coupled components in communication with one another.

The invention further provides an OFDM signal decoder, the decoder comprising:

a first input for a complex received signal value (yᵢ) for a carrier of said OFDM signal; a second input for a complex channel estimate (hᵢ) for said carrier; a pre-processor coupled to said first and second inputs to determine and output an intermediate signal value (ρᵢrᵢ) comprising a product of said received signal value and a complex conjugate of said channel estimate (yᵢhᵢ*); and a decoder coupled to an output of said pre-processor to decode said UWB OFDM signal using said intermediate signal value.

In preferred embodiments the decoded OFDM signal comprises a UWB OFDM signal. In such a case a method as described above is preferably implemented in hardware, for speed.

The invention still further provides decoders for decoding a DCM modulated OFDM signal according to the above-described methods of aspects of the invention, comprising means to implement the above-described methods.

### BRIEF DESCRIPTION OF THE DRAWINGS

These and other aspects of the invention will now be further described, by way of example only, with reference to the accompanying figures in which:

FIGS. 1a and 1b show, respectively, first and second constellations for UWB DCM OFDM, and a schematic illustration of joint max-log DCM decoding according to an embodiment of the invention;

FIGS. 2a to 2d show, respectively, a block diagram of a DCM max-log decoder according to an embodiment of the invention, a pre-processing module for the decoder of FIG. 2a, an SNR determination module for the decoder of FIG. 2a ,and a multi-carrier joint max-log QPSK decoder;

FIG. 3 shows a graph of packet error rate against signal-to-noise ratio in dB showing performance of an embodiment of a decoder of the type shown in FIG. 2a in combination with a Viterbi decoder;

FIGS. 4a to 4c illustrate the relative positions of thermal and quantisation noise levels as received signal strength varies (not to scale);

FIG. 5 illustrates, schematically, variation of bit/packet error rate with received signal strength illustrating the effect of the changing relative quantisation noise level shown in FIGS. 4a to 4c;

FIG. 6 shows a block diagram of a digital OFDM UWB transmitter sub-system;

FIG. 7 shows a block diagram of a digital OFDM UWB receiver sub-system; and

FIGS. 8a and 8b show, respectively, a block diagram of a PHY hardware implementation for an OFDM UWB transceiver and an example RF front end for the receiver of FIG. 8a.

### DETAILED DESCRIPTION OF PREFERRED EMBODIMENTS

If we assume no ISI/ICI and no phase noise then in an OFDM receiver the output of the FFT (Fast Fourier Transform) for each carrier, k, is given by,

yₖ=hₖxₖ+nₖ

Where xₖ is the transmitted constellation point, hₖ is complex channel response and nₖ is complex white Gaussian noise of zero mean and variance σ²/2 per dimension. The k subscript will be dropped to simplify the following equations but it should be assumed to be present.

Since interleaving is used on the coded bits prior to the QAM modulator then maximum likelihood decoding would require joint demodulation and convolutional decoding which makes it almost impossible to perform in practice. However the Maximum A-Posterior Sequence Estimation (MAPSE) is possible. In this instance the data is de-mapped into soft-bits, de-interleaved and decoded with a Viterbi decoder. Rather then estimate the most likely symbol sequence it attempts to estimate the most likely bit sequence for a given interleaving function. Using this approach the log-likelihood ratios (LLR) for an M-ary QAM for bit bᵢ, i=0,1, . . . M on carrier k, is defined as,

$$LLR ( {b}_{i} ) = log ( \frac{P ( {b}_{i} = 1 \vert y )}{P ( {b}_{i} = 0 \vert y )} )$$

It is this metric that the Viterbi decoder is trying to minimise for a given bit sequence. For any given constellation, separate it into two disjoint sets. One set, S1, is the set of all constellation points for which bᵢ=1 and the other SO is the set of all points for which bᵢ=0. For example for 16 QAM there will be eight points in S1 and the other eight in S0. The LLR is now,

$$LLR ( {b}_{i} ) = log ( \frac{{\sum }_{α ∈ S 1} P ( s = α \vert y )}{{\sum }_{β ∈ S 0} P ( s = β \vert y )} )$$

Assuming all constellation points are equally likely (which should be true since the data is scrambled) and using Bayes' rule then,

$$LLR ( {b}_{i} ) = log ( \frac{{\sum }_{α ∈ S 1} f ( y \vert s = α )}{{\sum }_{β ∈ S 0} f ( y \vert s = β )} )$$

Now since we assume that the noise is AWGN then,

$$f ( y \vert s = α ) = \frac{1}{σ \sqrt{π}} exp ( \frac{- 1}{{σ}^{2}} {‖ y - α h ‖}^{2} )$$

And so the LLR can be written as,

$$LLR ( {b}_{i} ) = log ( \frac{{\sum }_{{x}_{i} ∈ S 1} exp ( \frac{- 1}{{σ}^{2}} {‖ y - {x}_{i} h ‖}^{2} )}{{\sum }_{{x}_{j} ∈ S 0} exp ( \frac{- 1}{{σ}^{2}} {‖ y - {x}_{j} h ‖}^{2} )} )$$

Note that the LLRs above are the optimum soft decisions in the MAPSE sense for the Viterbi decoder (i.e. we can't do any better). The above equation is difficult to implement in hardware since it requires exponentials and logs and sums over several constellation points. A simplification, known as the max-log approximation can be made. Namely,

$$log ( {\sum }_{j} exp ( - {X}_{j} ) ) \approx {max}_{j} ( - {X}_{j} ) = - {min}_{j} ( {X}_{j} )$$

This simplifies the LLR to,

$$LLR ( {b}_{i} ) = \frac{1}{{σ}^{2}} \{ {min}_{{x}_{j} ∈ S 0} {‖ y - {x}_{j} h ‖}^{2} - {min}_{{x}_{i} ∈ S 1} {‖ y - {x}_{i} h ‖}^{2} \}$$

The term (y−xᵢh) can be re-written as, h(y/h−xᵢ). This gives an equivalent LLR formulation of,

$$LLR ( {b}_{i} ) = \frac{{‖ h ‖}^{2}}{{σ}^{2}} \{ {min}_{{x}_{j} ∈ S 0} {‖ \frac{y}{h} - {x}_{j} ‖}^{2} - {min}_{{x}_{i} ∈ S 1} {‖ \frac{y}{h} - {x}_{i} ‖}^{2} \}$$

This form implies that the received signal, y, is first corrected by the channel estimate h. A soft decision is then generated by comparing to nearest constellation points and then this value is weighted by the SNR of the carrier.

### QPSK Modes

In the “MultiBand OFDM Physical Layer Specification, the 53.3 Mbps and 80 Mbps rates use QPSK for the data carriers but in addition the same information is carried on 4 separate carriers. Thus in this case we use LLRs for the bits given by,

$$LLR ( {b}_{i} ) = log ( \frac{{\sum }_{{x}_{i} ∈ S 1} exp ( {\sum }_{k = 1}^{4} \frac{- {\vert {h}_{k} \vert}^{2}}{{σ}_{k}^{2}} {‖ \frac{{y}_{k}}{{h}_{k}} - {x}_{i} ‖}^{2} )}{{\sum }_{{x}_{ji} ∈ S 1} exp ( {\sum }_{k = 1}^{4} \frac{- {\vert {h}_{k} \vert}^{2}}{{σ}_{k}^{2}} {‖ \frac{{y}_{k}}{{h}_{k}} - {x}_{j} ‖}^{2} )} )$$

Using the max-log approximation this reduces to,

$$\begin{matrix}LLR ( {b}_{n} ) = {min}_{{x}_{j} ∈ S 0} ( {ρ}_{1} {‖ {r}_{1} - {x}_{j} ‖}^{2} + {ρ}_{2} {‖ {r}_{2} - {x}_{j} ‖}^{2} + {ρ}_{3} {‖ {r}_{3} - {x}_{j} ‖}^{2} + {ρ}_{4} {‖ {r}_{4} - {x}_{j} ‖}^{2} ) \\ - {min}_{{x}_{i} ∈ S 1} ( {ρ}_{1} {‖ {r}_{1} - {x}_{i} ‖}^{2} + {ρ}_{2} {‖ {r}_{2} - {x}_{i} ‖}^{2} + {ρ}_{3} {‖ {r}_{3} - {x}_{i} ‖}^{2} + {ρ}_{4} {‖ {r}_{4} - {x}_{i} ‖}^{2} )\end{matrix}$$

Note that:

r₁=y₁/h₁ is the corrected constellation point of the 1^{st} QPSK carrier where y₁ is the FFT output and h₁ is the channel estimate.

r₂=y₂/h₂ is the corresponding constellation point of the corresponding 2^{nd} QPSK carrier and so on.

Here ρₙ=|hₙ|²/σₙ² is the SNR of the nth carrier (or channel power if SNR not available)

The QPSK encoding table is as given below, with a normalisation factor of 1/√2.

| Input Bit | I- | Q- |
|---|---|---|
| (b[2k], b[2k+1]) | out | out |
| 00 | −1 | −1 |
| 01 | −1 | 1 |
| 10 | 1 | −1 |
| 11 | 1 | 1 |

Note that each bit is constant in the I or Q direction. This means that we can separate real, [symbol] , and imaginary, [symbol] , parts without any loss in generality, (that is, there is no loss in the possibilities represented). This simplifies the resulting LLR to,

$$\begin{matrix}LLR ( {b}_{0} ) = {\sum }_{k = 1}^{4} {{ρ}_{k} ( ℛ ( {r}_{k} ) + \frac{1}{\sqrt{2}} )}^{2} - {{ρ}_{k} ( ℛ ( {r}_{k} ) - \frac{1}{\sqrt{2}} )}^{2} \\ = \frac{4}{\sqrt{2}} ( {ρ}_{1} ℛ ( {r}_{1} ) + {ρ}_{2} ℛ ( {r}_{2} ) + {ρ}_{3} ℛ ( {r}_{3} ) + {ρ}_{4} ℛ ( {r}_{4} ) ) \\ LLR ( {b}_{1} ) = {\sum }_{k = 1}^{4} {{ρ}_{k} ( 𝒥 ( {r}_{k} ) + \frac{1}{\sqrt{2}} )}^{2} - {{ρ}_{k} ( 𝒥 ( {r}_{k} ) - \frac{1}{\sqrt{2}} )}^{2} \\ = \frac{4}{\sqrt{2}} ( {ρ}_{1} 𝒥 ( {r}_{1} ) + {ρ}_{2} 𝒥 ( {r}_{2} ) + {ρ}_{3} 𝒥 ( {r}_{3} ) + {ρ}_{4} 𝒥 ( {r}_{4} ) )\end{matrix}$$

Note that the above means that the soft decision can be generated individually for each carrier and then added to generate the overall LLR for a bit spread across 4 carriers. The other QPSK rates use the same principle except that only two carriers are used instead of four.

Note that here

$${ρ}_{n} {r}_{n} = \frac{{\vert {h}_{n} \vert}^{2}}{{σ}_{n}^{2}} \cdot \frac{{y}_{n}}{{h}_{n}} = \frac{{y}_{n} {h}_{n}^{*}}{{σ}_{n}^{2}}$$

where hᵢ is the channel estimate and yᵢ is the FFT output (optionally σₙ² may be omitted, that is set to unity). This form of the expression removes the need to perform a vector divide to generate

$${r}_{i} = \frac{{y}_{i}}{{h}_{i}} ,$$

and allows the final LLR expressions to be rewritten as:

$$LLR ( {b}_{0} ) = \frac{4}{\sqrt{2}} ℛ ( \frac{{y}_{1} {h}_{1}^{*}}{{σ}_{1}^{2}} + \frac{{y}_{2} {h}_{2}^{*}}{{σ}_{2}^{2}} + \frac{{y}_{3} {h}_{3}^{*}}{{σ}_{3}^{2}} + \frac{{y}_{4} {h}_{4}^{*}}{{σ}_{4}^{2}} )$$

$$LLR ( {b}_{1} ) = \frac{4}{\sqrt{2}} 𝒥 ( \frac{{y}_{1} {h}_{1}^{*}}{{σ}_{1}^{2}} + \frac{{y}_{2} {h}_{2}^{*}}{{σ}_{2}^{2}} + \frac{{y}_{3} {h}_{3}^{*}}{{σ}_{3}^{2}} + \frac{{y}_{4} {h}_{4}^{*}}{{σ}_{4}^{2}} )$$

Hence for QSPK the soft decisions are just the real or imaginary part of the corrected constellation weighted by their respective SNR, albeit preferably expressed in the above form (in which equalised constellation points are not explicitly determined).

It can be seen from the above that rather than separately equalising the received signal data to determine a corrected received signal value (y/h) which may be plotted on a constellation diagram and then demodulating the corrected received signal value by, say, determining a nearest constellation point, in preferred embodiments of our technique we do not generate a constellation but instead work with modified or intermediate signal values which, in particular, do not require a division by a channel estimate.

### QPSK Mode SNR Calculation

The expression for SNR is given by

$${SNR}_{dB} = - 10 \cdot {log}_{10} ( \frac{\sum noise\_power}{\sum signal\_power} )$$

QPSK modulation uses up to four carriers which contribute to joint the encoding quality. The resulting expression for the joint SNR is given by:

$${SNR}_{dB} ( {r}_{1} , {r}_{2} , {r}_{3} , {r}_{4} ) = - 10 \cdot {log}_{10} ( \frac{\begin{matrix}\sum {ρ}_{1} {‖ {r}_{1} - {x}_{d} ‖}^{2} + {ρ}_{2} {‖ {r}_{2} - {x}_{d} ‖}^{2} + \\ {ρ}_{3} {‖ {r}_{3} - {x}_{d} ‖}^{2} + {ρ}_{4} {‖ {r}_{4} - {x}_{d} ‖}^{2}\end{matrix}}{\sum {ρ}_{1} + {ρ}_{2} + {ρ}_{3} + {ρ}_{4}} )$$

Given the normalisation ∥rₙ∥²=∥x_{d}∥=1 the above expression can be rewritten in terms of the LLR expressions:

$${SNR}_{dB} ( {y}_{1} , {y}_{2} , {y}_{3} , {y}_{4} ) = - 10 \cdot {log}_{10} ( \frac{\begin{matrix}\sum {ρ}_{1} + {ρ}_{2} + {ρ}_{3} + {ρ}_{4} + {ρ}_{1} {‖ {r}_{1} ‖}^{2} + {ρ}_{2} {‖ {r}_{2} ‖}^{2} {ρ}_{3} {‖ {r}_{3} ‖}^{2} {ρ}_{4} {‖ {r}_{4} ‖}^{2} - \\ \frac{1}{2 \sqrt{2}} ABS ( LLR ( {b}_{0} ) ) - \frac{1}{2 \sqrt{2}} ABS ( LLR ( {b}_{1} ) )\end{matrix}}{\sum {ρ}_{1} + {ρ}_{2} + {ρ}_{3} + {ρ}_{4}} )$$

It can then be seen that the SNR is a function of LLR(b₀) and LLR (b₁), more specifically of a difference between absolute values of LLR(b₀) and LLR (b₁), together with an SNR term (ρr²), summed over carriers.

### DCM Modes

For DCM modes the situation is more complex. In this instance 4 bits are transmitted on two separate 16 QAM carriers with different mappings. The fact that the mappings are different and that the reliability of each bit in a single 16 QAM constellation is not equally weighted means that we cannot just demodulate the bits separately (as in the QPSK case) but must perform a joint decode. In this instance we must treat the received vectors for a DCM carrier pair as a 4-dimensional point and find the LLR in this 4 dimensional space.

The LLR for the bit-i is given by,

$$LLR ( {b}_{i} ) = log ( \frac{{\sum }_{{x}_{i} ∈ S 1} exp ( \frac{- {\vert {h}_{1} \vert}^{2}}{{σ}_{1}^{2}} {‖ \frac{{y}_{1}}{{h}_{1}} - {x}_{i}^{1} ‖}^{2} + \frac{- {\vert {h}_{2} \vert}^{2}}{{σ}_{2}^{2}} {‖ \frac{{y}_{2}}{{h}_{2}} - {x}_{i}^{2} ‖}^{2} )}{{\sum }_{{x}_{j} ∈ S 0} exp ( \frac{- {\vert {h}_{1} \vert}^{2}}{{σ}_{1}^{2}} {‖ \frac{{y}_{1}}{{h}_{1}} - {x}_{j}^{1} ‖}^{2} + \frac{- {\vert {h}_{2} \vert}^{2}}{{σ}_{2}^{2}} {‖ \frac{{y}_{2}}{{h}_{2}} - {x}_{j}^{2} ‖}^{2} )} )$$

Using the max-log approximation this reduces to,

$$LLR ( {b}_{n} ) = {min}_{{x}_{j} ∈ S 0} ( {ρ}_{1} {‖ {r}_{1} - {r}_{j}^{1} ‖}^{2} + {ρ}_{2} {‖ {r}_{2} - {r}_{j}^{2} ‖}^{2} ) - {min}_{{x}_{i} ∈ S 1} ( {ρ}_{1} {‖ {r}_{1} - {r}_{i}^{1} ‖}^{2} + {ρ}_{2} {‖ {r}_{2} - {r}_{i}^{2} ‖}^{2} )$$

Where r₁=y₁/h₁ identifies the corrected constellation point on the 1^{st} DCM carrier and r₂=y₂/h₂ is the corresponding constellation point of the corresponding 2^{nd} DCM carrier. Here ρₙ=|hₙ|²/σₙ² is the SNR of the nth carrier (or channel power if SNR not available) and xₙ¹ and xₙ² are corresponding Tx constellation points for each of the two DCM carriers. Note that for DCM the each bit is constant in the I or Q direction. This means that we can separate real, [symbol] , and imaginary, [symbol] , parts without any loss in generality (as shown below). For bit 0 this simplifies the resulting LLR to,

$$LLR ( {b}_{0} ) = min ( \begin{matrix}{{ρ}_{1} ( ℛ ( {r}_{1} ) + \frac{1}{\sqrt{10}} )}^{2} + {{ρ}_{2} ( ℛ ( {r}_{2} ) + \frac{3}{\sqrt{10}} )}^{2} \\ {{ρ}_{1} ( ℛ ( {r}_{1} ) + \frac{3}{\sqrt{10}} )}^{2} + {{ρ}_{2} ( ℛ ( {r}_{2} ) - \frac{1}{\sqrt{10}} )}^{2}\end{matrix} ) - min ( \begin{matrix}{{ρ}_{1} ( ℛ ( {r}_{1} ) - \frac{1}{\sqrt{10}} )}^{2} + {{ρ}_{2} ( ℛ ( {r}_{2} ) - \frac{3}{\sqrt{10}} )}^{2} \\ {{ρ}_{1} ( ℛ ( {r}_{1} ) - \frac{3}{\sqrt{10}} )}^{2} + {{ρ}_{2} ( ℛ ( {r}_{2} ) + \frac{1}{\sqrt{10}} )}^{2}\end{matrix} )$$

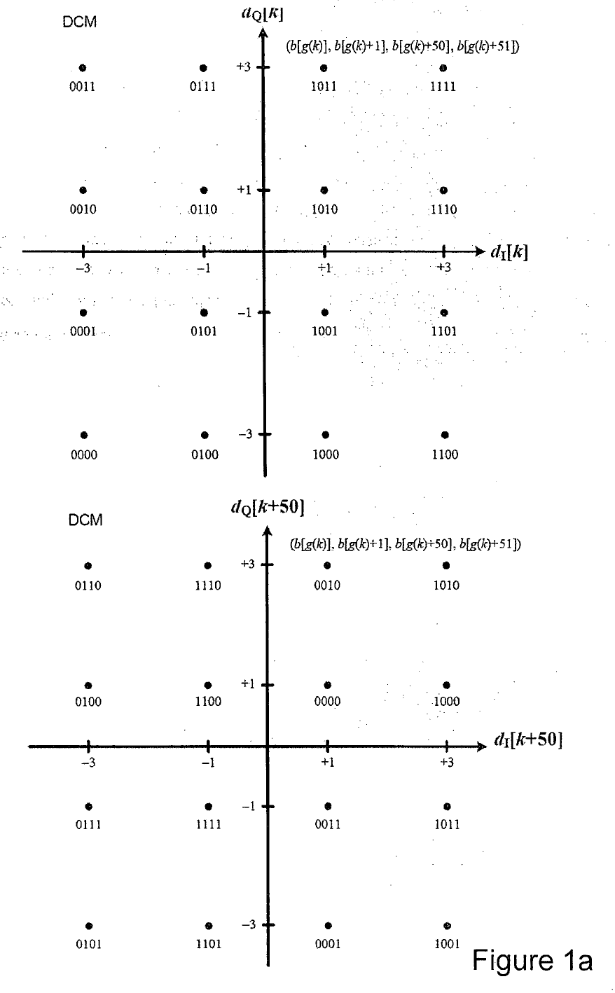

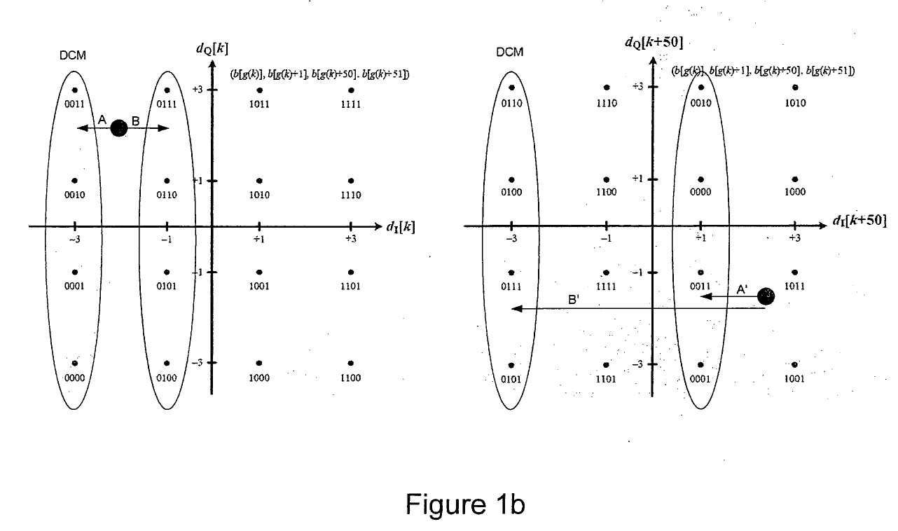

Consider the first (min) term: Referring back to FIG. 1a and the DCM constellation table, the real (I) values for xⱼ=0 are −3 and −1 in the first constellation and −3 and +1 in the second constellation (also noting the 1/√10 normalisation factor and the minus sign before xⱼ).

Consider now the example of FIG. 1b. The ringed columns show all values of x₀=0; in each constellation only two virtual columns have zeros. Thus the distance to x₀=0 can be measured in one dimension. If the dark spot represents and equalised received signal value the left hand (min) term in the above equation can be seen to be

$$min ( \begin{matrix}{ρ}_{1} A + {ρ}_{2} {A}^{′} \\ {ρ}_{1} B + {ρ}_{2} {B}^{′}\end{matrix} )$$

The right hand min ( ) term corresponds for x₀=1. In practice, however (as noted previously and explained further below) the position of an equalised received signal value need not be determined explicitly.

Note that in the above equation ρ₁ [symbol] (r₁)² and ρ₂ [symbol] (r₂)² will always cancel. In addition as far as finding the min of both comparisons these terms are present in both and so are not required. This gives,

$$LRR ( {b}_{0} ) = min ( \begin{matrix}{ρ}_{1} ( \frac{2}{\sqrt{10}} ℜ ( {r}_{1} ) + \frac{1}{10} ) + {ρ}_{2} ( \frac{6}{\sqrt{10}} ℜ ( {r}_{2} ) + \frac{9}{10} ) \\ {ρ}_{1} ( \frac{6}{\sqrt{10}} ℜ ( {r}_{1} ) + \frac{9}{10} ) + {ρ}_{2} ( \frac{- 2}{\sqrt{10}} ℜ ( {r}_{2} ) + \frac{1}{10} )\end{matrix} ) - min ( \begin{matrix}{ρ}_{1} ( \frac{- 2}{\sqrt{10}} ℜ ( {r}_{1} ) + \frac{1}{10} ) + {ρ}_{2} ( \frac{- 6}{\sqrt{10}} ℜ ( {r}_{2} ) + \frac{9}{10} ) \\ {{ρ}_{1} ( \frac{- 6}{\sqrt{10}} ℜ ( {r}_{1} ) + \frac{9}{10} )}^{2} + {ρ}_{2} ( \frac{2}{\sqrt{10}} ℜ ( {r}_{2} ) + \frac{1}{10} )\end{matrix} )$$

A similar analysis can be performed for the other 3 bits of the DCM constellation.

Bit 2 is the same at bit 0 except that the real parts of the received points are replaced by the imaginary parts. The LLR for the remaining bits are shown below,

$$LRR ( {b}_{1} ) = min ( \begin{matrix}{ρ}_{1} ( \frac{6}{\sqrt{10}} ℜ ( {r}_{1} ) + \frac{9}{10} ) + {ρ}_{2} ( \frac{- 2}{\sqrt{10}} ℜ ( {r}_{2} ) + \frac{1}{10} ) \\ {ρ}_{1} ( \frac{- 2}{\sqrt{10}} ℜ ( {r}_{1} ) + \frac{1}{10} ) + {ρ}_{2} ( \frac{- 6}{\sqrt{10}} ℜ ( {r}_{2} ) + \frac{9}{10} )\end{matrix} ) - min ( \begin{matrix}{ρ}_{1} ( \frac{2}{\sqrt{10}} ℜ ( {r}_{1} ) + \frac{1}{10} ) + {ρ}_{2} ( \frac{6}{\sqrt{10}} ℜ ( {r}_{2} ) + \frac{9}{10} ) \\ {{ρ}_{1} ( \frac{- 6}{\sqrt{10}} ℜ ( {r}_{1} ) + \frac{9}{10} )}^{2} + {ρ}_{2} ( \frac{2}{\sqrt{10}} ℜ ( {r}_{2} ) + \frac{1}{10} )\end{matrix} )$$

$$LLR ( {b}_{2} ) = min ( \begin{matrix}{ρ}_{1} ( \frac{2}{\sqrt{10}} ( {r}_{1} ) + \frac{1}{10} ) + {ρ}_{2} ( \frac{6}{\sqrt{10}} ( {r}_{2} ) + \frac{9}{10} ) \\ {ρ}_{1} ( \frac{6}{\sqrt{10}} ( {r}_{1} ) + \frac{9}{10} ) + {ρ}_{2} ( \frac{- 2}{\sqrt{10}} ( {r}_{2} ) + \frac{1}{10} )\end{matrix} ) - min ( \begin{matrix}{ρ}_{1} ( \frac{- 2}{\sqrt{10}} ( {r}_{1} ) + \frac{1}{10} ) + {ρ}_{2} ( \frac{- 6}{\sqrt{10}} ( {r}_{2} ) + \frac{9}{10} ) \\ {{ρ}_{1} ( \frac{- 6}{\sqrt{10}} ( {r}_{1} ) + \frac{9}{10} )}^{2} + {ρ}_{2} ( \frac{2}{\sqrt{10}} ( {r}_{2} ) + \frac{1}{10} )\end{matrix} )$$

$$LLR ( {b}_{3} ) = min ( \begin{matrix}{ρ}_{1} ( \frac{6}{\sqrt{10}} ( {r}_{1} ) + \frac{9}{10} ) + {ρ}_{2} ( \frac{- 2}{\sqrt{10}} ( {r}_{2} ) + \frac{1}{10} ) \\ {ρ}_{1} ( \frac{- 2}{\sqrt{10}} ( {r}_{1} ) + \frac{1}{10} ) + {ρ}_{2} ( \frac{- 6}{\sqrt{10}} ( {r}_{2} ) + \frac{9}{10} )\end{matrix} ) - min ( \begin{matrix}{ρ}_{1} ( \frac{2}{\sqrt{10}} ( {r}_{1} ) + \frac{1}{10} ) + {ρ}_{2} ( \frac{6}{\sqrt{10}} ( {r}_{2} ) + \frac{9}{10} ) \\ {{ρ}_{1} ( \frac{- 6}{\sqrt{10}} ( {r}_{1} ) + \frac{9}{10} )}^{2} + {ρ}_{2} ( \frac{2}{\sqrt{10}} ( {r}_{2} ) + \frac{1}{10} )\end{matrix} )$$

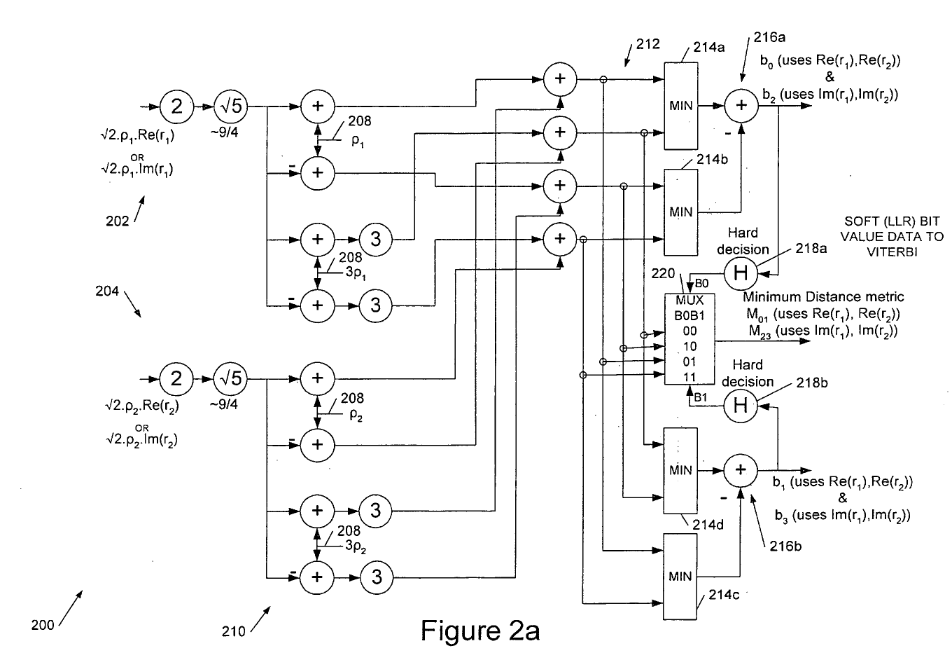

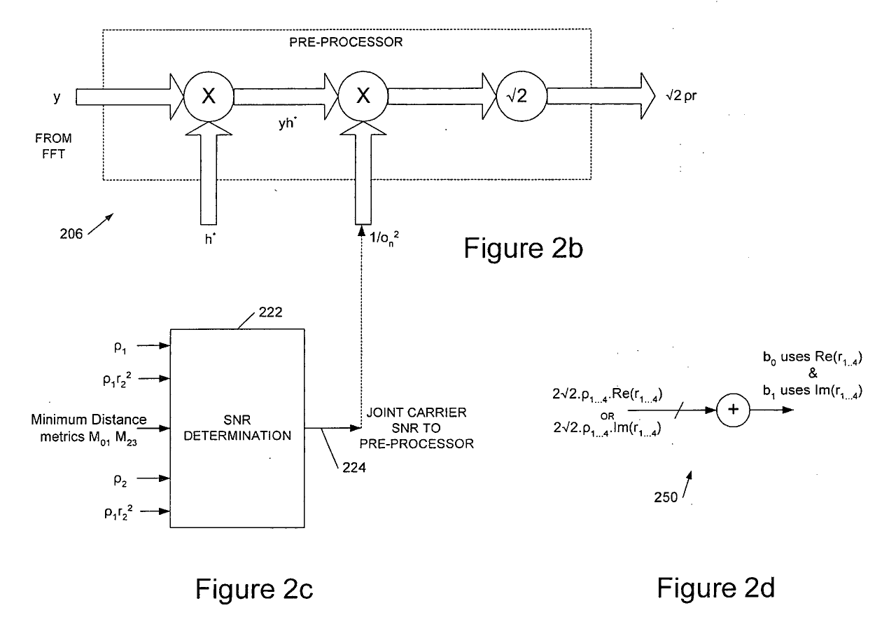

By factoring such that 2\sqrt{10}ρᵢ [symbol] (rᵢ) is present gives the final form of the DCM decoder as shown in FIG. 2a:

$$LLR ( {b}_{0} ) = \frac{1}{10} min ( \begin{matrix}2 \sqrt{10} ( {ρ}_{1} ℜ ( {r}_{1} ) + 3 {ρ}_{2} ℜ ( {r}_{2} ) ) + ( {ρ}_{1} + 9 {ρ}_{2} ) \\ 2 \sqrt{10} ( 3 {ρ}_{1} ℜ ( {r}_{1} ) - {ρ}_{2} ℜ ( {r}_{2} ) ) + ( 9 {ρ}_{1} + {ρ}_{2} )\end{matrix} ) - \frac{1}{10} min ( \begin{matrix}2 \sqrt{10} ( - {ρ}_{1} ℜ ( {r}_{1} ) - 3 {ρ}_{2} ℜ ( {r}_{2} ) ) + ( {ρ}_{1} + 9 {ρ}_{2} ) \\ 2 \sqrt{10} ( 3 {ρ}_{1} ℜ ( {r}_{1} ) + {ρ}_{2} ℜ ( {r}_{2} ) ) + ( 9 {ρ}_{1} + {ρ}_{2} )\end{matrix} )$$

This form is still optimum in the max-log sense of MAPSE. Note that ρᵢ [symbol] (rᵢ)= [symbol] (yᵢhᵢ*) where hᵢ is the channel estimate and yᵢ is the FFT output (omitting the σ²). This form of the expression removes the need to perform a vector divide to generate

$${r}_{i} = \frac{{y}_{i}}{{h}_{i}}$$

### DCM Mode SNR Calculation

The expression for SNR is given by

$${SNR}_{dB} = - 10 \cdot {log}_{10} ( \sum \frac{noise\_power}{signal\_power} )$$

DCM modulation uses two carriers which contribute jointly to the encoding quality. As a result the expression for the SNR of a DCM joint carrier pair is as follows:

$${SNR}_{dB} ( {r}_{1} , {r}_{2} ) = - 10 \cdot {log}_{10} ( \sum \frac{{ρ}_{1} {‖ {r}_{1} - {x}_{d}^{1} ‖}^{2} + {ρ}_{2} {‖ {r}_{2} - {x}_{d}^{2} ‖}^{2}}{{ρ}_{1} + {ρ}_{2}} )$$

Where x_{d}ⁿ is the vector associated with the hard-decision output of the DCM decoder for carrier n. The sum is performed over all symbols in the frame.

The numerator of the above expression is identical to the distance function used by the DCM decoder. Some rearranging achieves considerable simplification:

$${SNR}_{dB} ( {r}_{1} , {r}_{2} ) = - 10 \cdot {log}_{10} ( \sum \frac{\begin{matrix}{ρ}_{1} ( {ℜ ( {r}_{1} - {x}_{d}^{1} )}^{2} + { ( {r}_{1} - {x}_{d}^{1} )}^{2} ) + \\ {ρ}_{2} ( {ℜ ( {r}_{2} - {x}_{d}^{2} )}^{2} + { ( {r}_{2} - {x}_{d}^{2} )}^{2} )\end{matrix}}{{ρ}_{1} + {ρ}_{2}} )$$

$${SNR}_{dB} ( {r}_{1} , {r}_{2} ) = - 10 \cdot {log}_{10} ( \sum \frac{\begin{matrix}{{ρ}_{1} ( ℜ ( {r}_{1} - {x}_{d}^{1} ) )}^{2} + {{ρ}_{2} ( ℜ ( {r}_{2} - {x}_{d}^{2} ) )}^{2} + \\ {{ρ}_{1} ( ( {r}_{1} - {x}_{d}^{1} ) )}^{2} + {{ρ}_{2} ( ( {r}_{2} - {x}_{d}^{2} ) )}^{2}\end{matrix}}{{ρ}_{1} + {ρ}_{2}} )$$

$${SNR}_{dB} ( {r}_{1} , {r}_{2} ) = - 10 \cdot {log}_{10} ( \sum \frac{\begin{matrix}\begin{matrix}{ρ}_{1} ( {ℜ ( {r}_{1} )}^{2} - 2 ℜ ( {r}_{1} ) ℜ ( {x}_{d}^{1} ) + {ℜ ( {x}_{d}^{1} )}^{2} ) + \\ {ρ}_{2} ( {ℜ ( {r}_{2} )}^{2} - 2 ℜ ( {r}_{2} ) ℜ ( {x}_{d}^{2} ) + {ℜ ( {x}_{d}^{2} )}^{2} ) +\end{matrix} \\ \begin{matrix}{ρ}_{1} ( { ( {r}_{1} )}^{2} - 2 ( {r}_{1} ) ( {x}_{d}^{1} ) + { ( {x}_{d}^{1} )}^{2} ) + \\ {ρ}_{2} ( { ( {r}_{2} )}^{2} - 2 ( {r}_{2} ) ( {x}_{d}^{2} ) + { ( {x}_{d}^{2} )}^{2} )\end{matrix}\end{matrix}}{{ρ}_{1} + {ρ}_{2}} )$$

$${SNR}_{dB} ( {r}_{1} , {r}_{2} ) = - 10 \cdot {log}_{10} ( \sum \frac{\begin{matrix}\begin{matrix}{ρ}_{1} ( {ℜ ( {r}_{1} )}^{2} + { ( {r}_{1} )}^{2} ) + {ρ}_{1} ( - 2 ℜ ( {r}_{1} ) ℜ ( {x}_{d}^{1} ) + \\ ℜ {( {x}_{d}^{1} )}^{2} ) + {ρ}_{2} ( - 2 ℜ ( {r}_{2} ) ℜ ( {x}_{d}^{2} ) + {ℜ ( {x}_{d}^{2} )}^{2} ) +\end{matrix} \\ \begin{matrix}{ρ}_{2} ( {ℜ ( {r}_{2} )}^{2} + { ( {r}_{2} )}^{2} ) + {ρ}_{1} ( - 2 ( {r}_{1} ) ( {x}_{d}^{1} ) + \\ { ( {x}_{d}^{1} )}^{2} ) + {ρ}_{2} ( - 2 ( {r}_{2} ) ( {x}_{d}^{2} ) + { ( {x}_{d}^{2} )}^{2} )\end{matrix}\end{matrix}}{{ρ}_{1} + {ρ}_{2}} )$$

$${SNR}_{dB} ( {r}_{1} , {r}_{2} ) = - 10 \cdot {log}_{10} ( \sum \frac{\begin{matrix}{ρ}_{1} {‖ {r}_{1} ‖}^{2} + {ρ}_{1} ( - 2 ℜ ( {r}_{1} ) ℜ ( {x}_{d}^{1} ) + {ℜ ( {x}_{d}^{1} )}^{2} ) + \\ {ρ}_{2} ( - 2 ℜ ( {r}_{2} ) ℜ ( {x}_{d}^{2} ) + {ℜ ( {x}_{d}^{2} )}^{2} ) + \\ {ρ}_{2} {‖ {r}_{2} ‖}^{2} + {ρ}_{1} ( - 2 ( {r}_{1} ) ( {x}_{d}^{1} ) + { ( {x}_{d}^{1} )}^{2} ) + \\ {ρ}_{2} ( - 2 ( {r}_{2} ) ( {x}_{d}^{2} ) + { ( {x}_{d}^{2} )}^{2} )\end{matrix}}{{ρ}_{1} + {ρ}_{2}} )$$

Given

$${ρ}_{1} = \frac{{‖ {h}_{1} ‖}^{2}}{{σ}_{1}^{2}}$$

and

$${r}_{1} = \frac{{y}_{1}}{{h}_{1}}$$

where hᵢ is the channel estimate and y₁ is the FFT output gives:

$${SNR}_{dB} ( {r}_{1} , {r}_{2} ) = - 10 \cdot {log}_{10} ( \sum \frac{\begin{matrix}{‖ {y}_{1} ‖}^{2} - 2 ℜ ( {y}_{1} {h}_{1}^{*} ) ℜ ( {x}_{d}^{1} ) + {‖ {h}_{1} ‖}^{2} {ℜ ( {x}_{d}^{1} )}^{2} - \\ 2 ℜ ( {y}_{2} {h}_{2}^{*} ) ℜ ( {x}_{d}^{2} ) + {‖ {h}_{2} ‖}^{2} {ℜ ( {x}_{d}^{2} )}^{2} + \\ {‖ {y}_{2} ‖}^{2} - 2 ( {y}_{1} {h}_{1}^{*} ) ( {x}_{d}^{1} ) + {‖ {h}_{1} ‖}^{2} { ( {x}_{d}^{1} )}^{2} - \\ 2 ( {y}_{2} {h}_{2}^{*} ) ( {x}_{d}^{2} ) + {‖ {h}_{2} ‖}^{2} { ( {x}_{d}^{2} )}^{2}\end{matrix}}{{ρ}_{1} + {ρ}_{2}} )$$

For the hard-decision b₀=0 b₁=0 b₂=0 b₃=0 the SNR is given by:

$${SNR}_{dB} ( \frac{- 3 + i}{\sqrt{10}} , \frac{- 3 + i}{\sqrt{10}} ) = - 10 \cdot {log}_{10} ( \sum \frac{\begin{matrix}10 {ρ}_{1} {‖ {r}_{1} ‖}^{2} + ( - 6 \sqrt{10} {ρ}_{1} ℜ ( {r}_{1} ) + \\ 9 {ρ}_{1} - 6 \sqrt{10} {ρ}_{2} ℜ ( {r}_{2} ) + 9 {ρ}_{2} ) + \\ 10 {ρ}_{2} {‖ {r}_{2} ‖}^{2} + ( - 2 \sqrt{10} {ρ}_{1} ( {r}_{1} ) + \\ {ρ}_{1} - 2 \sqrt{10} {ρ}_{2} ( {r}_{2} ) + {ρ}_{2} )\end{matrix}}{10 ( {ρ}_{1} + {ρ}_{2} )} )$$

Each of the terms in the above equation is already computed when calculating the DCM soft-decision metric. Based on the hard-decision output of the DCM demodulator the appropriate terms can be selected. The general expression for SNR thus becomes:

$${SNR}_{dB} ( {r}_{1} , {r}_{2} ) = - 10 \cdot {log}_{10} ( \sum \frac{10 \cdot ( {ρ}_{1} {‖ {r}_{1} ‖}^{2} + {ρ}_{2} {‖ {r}_{2} ‖}^{2} ) + {m}_{01} + {m}_{23}}{10 \cdot ( {ρ}_{1} + {ρ}_{2} )} )$$

Where m₀₁ and m₂₃ are the distance metrics calculated in FIG. 1 associated with the hard-decision decode of b₀,b₁ and b₂,b₃respectively. In the above equation, broadly speaking the two distance terms (m), one from each of the real and imaginary components, represent a squared error component of the joint SNR.

Thus although the optimum soft decisions for use by the Viterbi are not easily implementable, by using a max-log approximation it is possible to derive nearly optimum soft decisions that are implementable for both QPSK and DCM modes of operation. An implementation of such a near-optimum DCM decoder 200 is shown in FIG. 2a.

Referring to FIG. 2, first and second inputs 202, 204 receive pre-processed data generated from received signal data and channel estimate data, preferably combined with noise level data, from a pre-processor 206 of the general type shown in FIG. 2b. Other inputs 208 receive values of ρ which broadly defines a signal power or signal-to-noise ratio for a carrier. Arithmetic processing blocks 210 are coupled to inputs 202, 204, 208 to implement the above-described DCM LLR calculations; the skilled person will appreciate that other configurations than those in FIG. 2a are possible. The outputs 212 of the arithmetic processing blocks 210 comprise the terms given above for DCM OFDM demodulation minimum values of which are to be selected (that is the terms within the brackets in min ( )). As illustrated; these separate implementations may comprise serial or parallel implementations of separate and/or shared hardware. A selection of the minimum terms is performed by two pairs of selectors 214a,b and 214c,d. Bit LLR values are determined by calculating a difference between the selected minimum values using summers 216a,b. A hard decision on the most likely bit values is made on the LLR data by hard decision unit 218a,b and these provide inputs to a multiplexer 220 which selects from amongst outputs 212 to provide a minimum distance metric (1 for each of the real and imaginary components processed).

FIG. 2c shows an SNR determination module 222 configured to implement the above-described DCM mode SNR calculation and to provide an SNR output 224. This SNR output may be employed to provide per carrier SNR data to pre-processor 206 to provide a feedback loop to obtain a better estimate of the SNR associated with a particular carrier, and hence of an associated bit LLR (the confidence in the bit value decreasing with decreasing SNR for the carrier or pair of DCM carriers).

FIG. 2d illustrates, schematically, a decoder 250 to implement the above-described 4-carrier QPSK mode signal decoding.

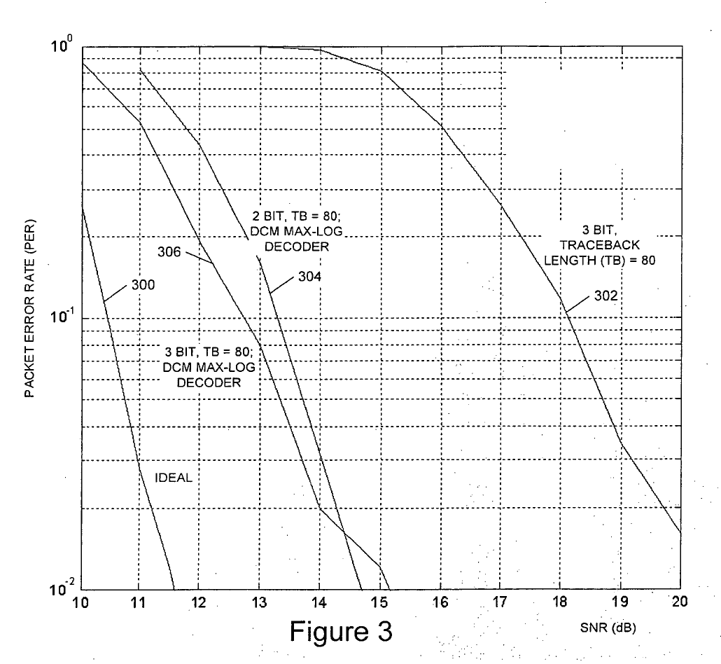

Referring now to FIG. 3 this shows packet error rate against signal-to-noise ratio in dB, comparing an ideal performance 300 with separate DCM carrier processing 302 and 2-bit 304 and 3-bit 306 LLR implementations of a joint DCM decoder as described above. The curves relate to a 480 Mbps signal in a multipath channel using a Viterbi decoder with a trace back length of 80. It can be seen that embodiments of decoder as described above can provide around 6 dB of performance gain; the equivalent curve to curve 302 but with a 2-bit LLR shows an approximately 10 dB performance gain. The difference between using 2-bit and 3-bit LLR (and also in the Viterbi decoder) is approximately 1 dB.

Referring again to the basic equation for the LLRs given above, this can be expressed in two equivalent forms, as shown below:

$$LLR ( {b}_{i} ) = \frac{1}{{σ}^{2}} \{ {min}_{{x}_{j} ∈ S0} {‖ y - {x}_{j} h ‖}^{2} - {min}_{{x}_{i} ∈ S1} {‖ y - {x}_{i} h ‖}^{2} \}$$

$$OR$$

$$LLR ( {b}_{i} ) = \frac{{‖ h ‖}^{2}}{{σ}^{2}} \{ {min}_{{x}_{j} ∈ S0} {‖ \frac{y}{h} - {x}_{j} ‖}^{2} - {min}_{{x}_{i} ∈ S1} {‖ \frac{y}{h} - {x}_{i} ‖}^{2} \}$$

With the latter form each sub-carrier out of the FFT is first corrected then de-mapped into soft-bits which are then weighted by the SNR of the sub-carrier from which the bit came.

The former form does not require channel correction or SNR weighting. Instead the sub-carrier out of the FFT is compared against a channel deformed version of the expected constellation points.

The skilled person will appreciate that in embodiments of a DCM decoder as described above the calculations performed may be based upon either form of the LLR. Thus embodiments of the invention are not restricted to the precise formulation of the decoder as expressed above but may instead use a different form of the decoder depending upon whether or not each subcarrier from the FFT stage is corrected.

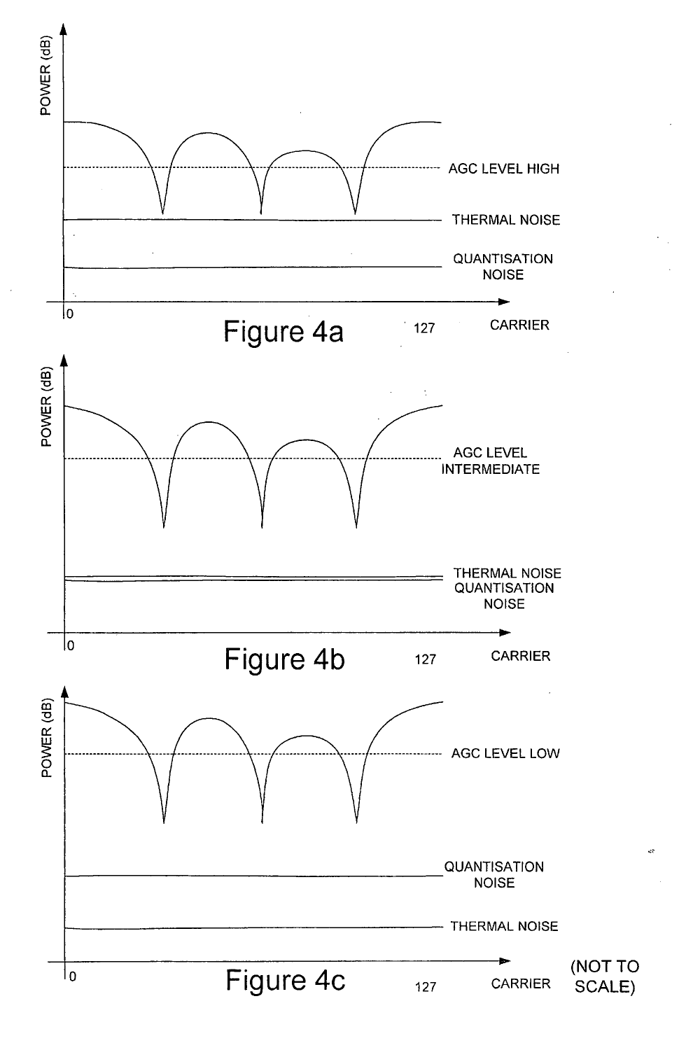

Referring now to FIGS. 4a to 4c, these illustrate, schematically, the effect of a changing signal level on the relative importance of thermal noise and quantisation noise (the illustrations are not to scale). It can be seen that for larger received signals the quantisation noise is relatively more important. In a receiver the designer will know where the thermal noise should be (the precise value is not important) and thus the AGC level can be used as an estimate of the thermal noise σ_{n,T}².

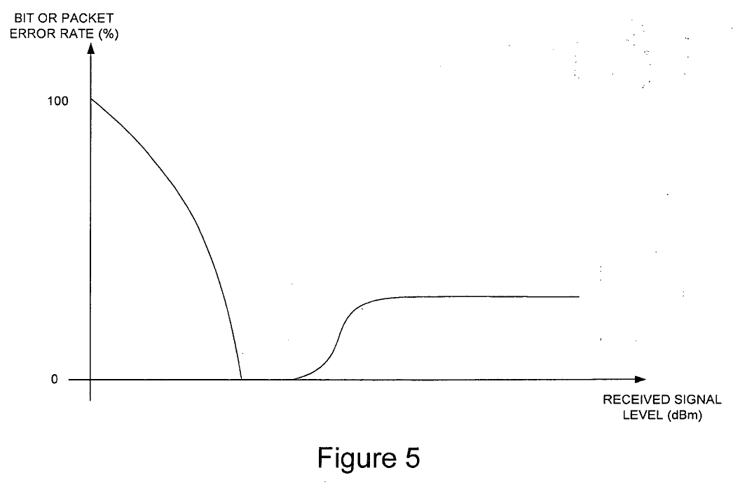

Referring now to FIG. 5, this shows the effect of quantisation noise on bit or packet error rate as the received signal level is varied. As can be seen, unexpectedly the result of the quantisation noise is that with apparently good signals the bit or packet error rate is higher than expected.

Referring back to FIG. 4, the distance to the quantisation noise σ_{n,Q}² is substantially fixed. Thus the quantisation noise σ_{n,Q}² may be modelled by, say, a register value and taken into account when determining a signal-to-noise ratio. More particularly, in the above-described expressions the noise σₙ² may be replaced by:

σₙ²=σ_{n,T}+σ_{n,Q}².

This helps to correct for the effects of quantisation noise, and hence further improve the LLR. Optionally a level of interference may also be included in the above expression for σₙ².

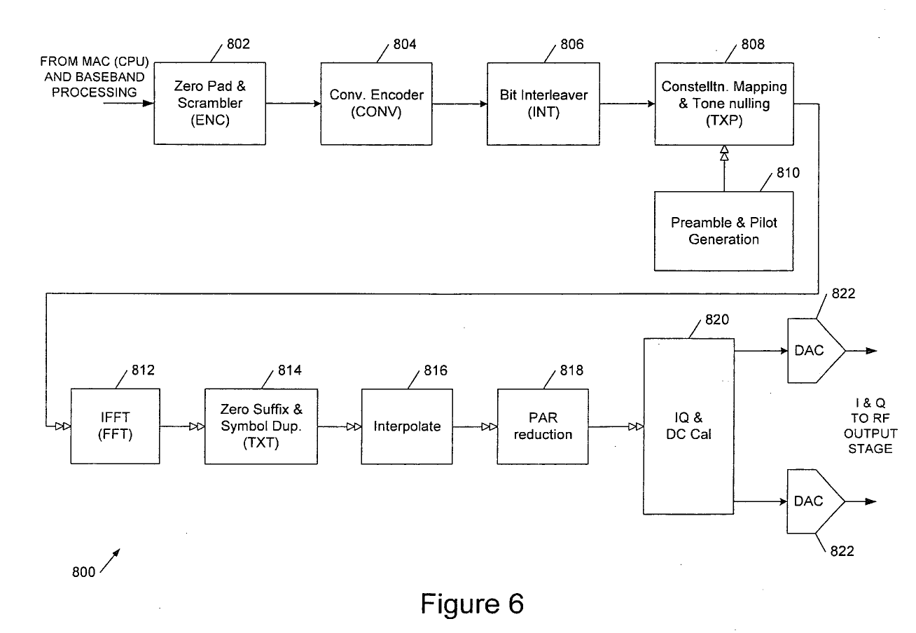

FIGS. 6 to 8 below show functional and structural block diagrams of an OFDM UWB transceiver which may incorporate a decoder as described above. Depending upon the implementation, as previously noted, the demodulator may replace both channel equalisation and demodulation blocks following the FFT unit.

Thus referring to FIG. 6, this shows a block diagram of a digital transmitter sub-system 800 of an OFDM UWB transceiver. The sub-system in FIG. 6 shows functional elements; in practice hardware, in particular the (I) FFT may be shared between transmitting and receiving portions of a transceiver since the transceiver is not transmitting and receiving at the same time.

Data for transmission from the MAC CPU (central processing unit) is provided to a zero padding and scrambling module 802 followed by a convolution encoder 804 for forward error correction and bit interleaver 806 prior to constellation mapping and tone nulling 808. At this point pilot tones are also inserted and a synchronisation sequence is added by a preamble and pilot generation module 810. An IFFT 812 is then performed followed by zero suffix and symbol duplication 814, interpolation 816 and peak-2-average power ratio (PAR) reduction 818 (with the aim of minimising the transmit power spectral density whilst still providing a reliable link for the transfer of information). The digital output at this stage is then converted to I and Q samples at approximately 1 Gsps in a stage 820 which is also able to perform DC calibration, and then these I and Q samples are converted to the analogue domain by a pair of DACs 822 and passed to the RF output stage.

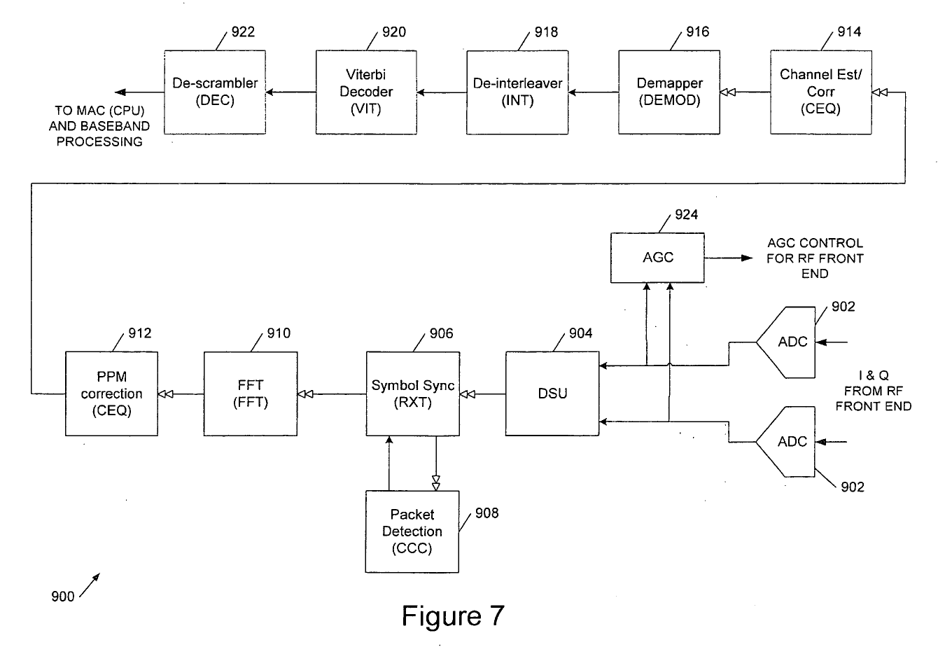

FIG. 7 shows a digital receiver sub-system 900 of a UWB OFDM transceiver.

Referring to FIG. 7, analogue I and Q signals from the RF front end are digitised by a pair of ADCs 902 and provided to a down sample unit (DSU) 904. Symbol synchronisation 906 is then performed in conjunction with packet detection/synchronisation 908 using the preamble synchronisation symbols. An FFT 910 then performs a conversion to the frequency domain and PPM (parts per million) clock correction 912 is performed followed by channel estimation and correlation 914. After this the received data is demodulated 916, de-interleaved 918, Viterbi decoded 920, de-scrambled 922 and the recovered data output to the MAC. An AGC (automatic gain control) unit is coupled to the outputs of a ADCs 902 and feeds back to the RF front end for AGC control, also on the control of the MAC.

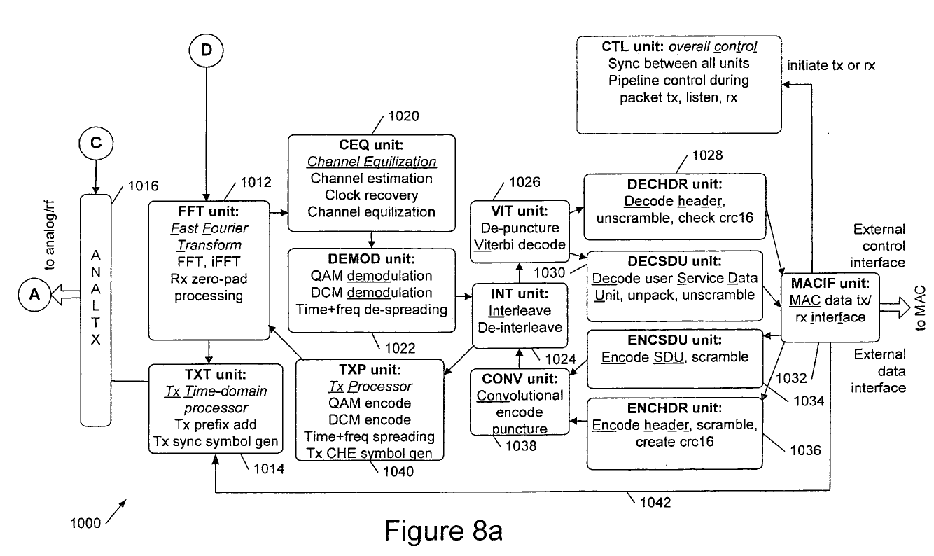

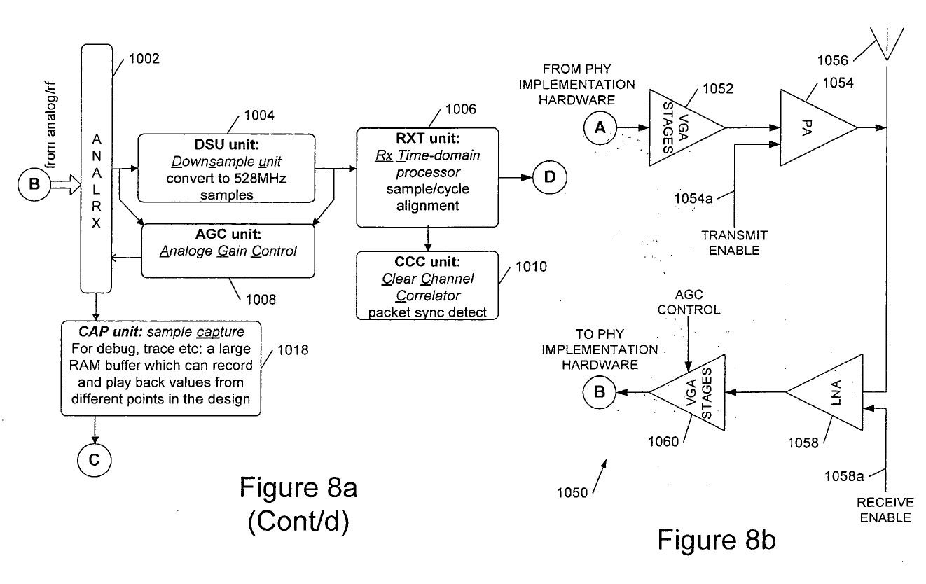

FIG. 8a shows a block diagram of physical hardware modules of a UWB OFDM transceiver 1000 which implements the transmitter and receiver functions depicted in FIGS. 6 and 7. The labels in brackets in the blocks of FIGS. 8 and 9 correspond with those of FIG. 8a, illustrating how the functional units are mapped to physical hardware.

Referring to FIG. 8a an analogue input 1002 provides a digital output to a DSU (down sample unit) 1004 which converts the incoming data at approximately 1 Gsps to 528 Mz samples, and provides an output to an RXT unit (receive time-domain processor) 1006 which performs sample/cycle alignment. An AGC unit 1008 is coupled around the DSU 1004 and to the analogue input 1002. The RXT unit provides an output to a CCC (clear channel correlator) unit 1010 which detects packet synchronisation; RXT unit 1006 also provides an output to an FFT unit 1012 which performs an FFT (when receiving) and IFFT (when transmitting) as well as receiver 0-padding processing. The FFT unit 1012 has an output to a TXT (transmit time-domain processor) unit 1014 which performs prefix addition and synchronisation symbol generation and provides an output to an analogue transmit interface 1016 which provides an analogue output to subsequent RF stages. A CAP (sample capture) unit 1018 is coupled to both the analogue receive interface 1002 and the analogue transmit interface 1016 to facilitate debugging, tracing and the like. Broadly speaking this comprises a large RAM (random access memory) buffer which can record and playback data captured from different points in the design.

The FFT unit 1012 provides an output to a CEQ (channel equalisation unit) 1020 which performs channel estimation, clock recovery, and channel equalisation and provides an output to a DEMOD unit 1022 which performs QAM demodulation, DCM (dual carrier modulation) demodulation, and time and frequency de-spreading, providing an output to an INT (interleave/de-interleave) unit 1024. The INT unit 1024 provides an output to a VIT (Viterbi decode) unit 1026 which also performs de-puncturing of the code, this providing outputs to a header decode (DECHDR) unit 1028 which also unscrambles the received data and performs a CRC 16 check, and to a decode user service data unit (DECSDU) unit 1030, which unpacks and unscrambles the received data. Both DECHDR unit 1028 and DECSDU unit 1030 provide output to a MAC interface (MACIF) unit 1032 which provides a transmit and receive data and control interface for the MAC.

In the transmit path the MACIF unit 1032 provides outputs to an ENCSDU unit 1034 which performs service data unit encoding and scrambling, and to an ENCHDR unit 1036 which performs header encoding and scrambling and also creates CRC 16 data. Both ENCSDU unit 1034 and ENCHDR unit 1036 provide output to a convolutional encode (CONV) unit 1038 which also performs puncturing of the encoded data, and this provides an output to the interleave (INT) unit 1024. The INT unit 1024 then provides an output to a transmit processor (TXP) unit 1040 which, in embodiments, performs QAM and DCM encoding, time-frequency spreading, and transmit channel estimation (CHE) symbol generation, providing an output to (I)FFT unit 1012, which in turn provides an output to TXT unit 1014 as previously described.

Referring now to FIG. 8b, this shows, schematically, RF input and output stages 1050 for the transceiver of FIG. 8a. The RF output stages comprise VGA stages 1052 followed by a power amplifier 1054 coupled to antenna 1056. The RF input stages comprise a low noise amplifier 1058, coupled to antenna 1056 and providing an output to further multiple VGA stages 1060 which provide an output to the analogue receive input 1002 of FIG. 8a. The power amplifier 1054 has a transmit enable control 1054a and the LNA 1058 has a receive enable control 1058a; these are controlled to switch rapidly between transmit and receive modes.

No doubt many other effective alternatives will occur to the skilled person. For example, although we have described some specific embodiments above using (weighted) Euclidean distance metrics (an L₂ norm) the skilled person will appreciate that many other (weighted) distance metrics may be employed, including, but not limited to, metrics measured by an L₁ norm and an L∞ norm.

It will be understood that the invention is not limited to the described embodiments and encompasses modifications apparent to those skilled in the art lying within the spirit and scope of the claims appended hereto.

What is claimed is:

1. A method of decoding a DCM (dual carrier modulation) modulated OFDM signal, the method comprising:
inputting first received signal data representing modulation of a multibit data symbol onto a first carrier of said OFDM signal using a first constellation;
inputting second received signal data representing modulation of said multibit data symbol onto a second, different carrier of said OFDM signal using a second, different constellation;
determining a combined representation of said first and second received signal data, said combined representation representing a combination of a distance of a point representing a bit value of said multibit data from a constellation point in each of said different constellations; and
determining a decoded value of a data bit of said multibit data using said combined representation.

2. A method as claimed in claim 1 wherein said determining of a decoded value comprises determining a log likelihood ratio (LLR) for said data bit, wherein said determining of said combined representation comprises determining combined distance data representing a sum of distances of a point representing a first binary value of said bit from corresponding constellation points in said first and second constellations at which said bit has said first binary value, said corresponding constellation points representing the same symbol in said different constellations, further comprising performing said determining for a plurality of said corresponding constellation points and selecting minimum combined distance data representing a minimum sum of said distances, performing said determining of said combined distance data for said plurality of corresponding constellation points for a second binary value of said bit and selecting minimum combined distance data representing a minimum sum of said distances, and determining a difference between said minimum combined distance data for said first and second binary values of said bit to determine said LLR.

3. A method as claimed in claim 1 wherein a said distance of a point representing a value of said bit from a said constellation point comprises a distance in one dimension between real (I) or imaginary (Q) component values of said bit and said constellation point.

4. A method as claimed in claim 1 wherein said combined representation comprises a linear combination of first and second intermediate data values, said first and second intermediate data values comprising respective products of said first and second received signal data and channel estimate data for said first and second carriers.

5. A method as claimed in claim 4 wherein said linear combination further comprises first and second additional terms representing a signal level or signal-to-noise ratio for said first and second carriers respectively.

6. A method as claimed in claim 4 wherein said linear combination is scaled by a value dependent on an estimated noise level.

7. A method as claimed in claim 6 wherein said estimated noise level includes a value for an estimated quantisation noise.

8. A method of determining a bit log likelihood ratio, LLR for a DCM (dual carrier modulation) modulated OFDM signal, the method comprising calculating a value for
$$LLR ( {b}_{n} ) = {min}_{{x}_{j} ∈ S0} ( {ρ}_{1} {‖ {r}_{1} - {x}_{j}^{1} ‖}^{2} + {ρ}_{2} {‖ {r}_{2} - {x}_{j}^{2} ‖}^{2} ) - {min}_{{x}_{i} ∈ S1} ( {ρ}_{1} {‖ {r}_{1} - {x}_{i}^{1} ‖}^{2} + {ρ}_{2} {‖ {r}_{2} - {x}_{i}^{2} ‖}^{2} )$$
where xⱼεS0 represents a set of DCM constellation points for which bₙ has a first binary value and xᵢεS1 represents a set of DCM constellation points for which bₙ has a second, different binary value; xⱼ¹ and xⱼ² and xᵢ¹ and xᵢ² represent constellation points for xⱼ and xᵢ in different first and second constellations of said DCM modulation respectively, the superscripts labelling constellations; ρ₁ and ρ₂ representing signal levels or signal-to-noise ratios of first and second OFDM carriers modulated using said first and second constellations respectively; r₁ and r₂ representing equalised received signal values from said first and second OFDM carriers respectively; min ( ) representing determining a minimum value; and ∥·∥ representing a distance metric.

9. A method as claimed in claim 8 wherein said determining of a minimum value comprises determining a minimum value of one or both of
αρ₁ [symbol] (r₁)+βρ₂ [symbol] (r₂)+γρ₁+δρ₂
and
α′ρ₁ [symbol] (r₁)+β′ρ₂ [symbol] (r₂)+γ′ρ₁+δ′ρ₂
where [symbol] and [symbol] denote taking real and imaginary components respectively, where α, α′, β, β′, γ, γ′, δ and δ′ are factors dependent on a mapping of said constellation points.

10. A method as claimed in claim 9 wherein said determining of ρ₁ [symbol] (r₁), ρ₂ [symbol] (r₂), ρ₁ [symbol] (r₁) and ρ₂ [symbol] (r₂) comprises, respectively, determining [symbol] (y₁h₁*), [symbol] (y₂h₂*), [symbol] ^{(y}₁h₁*) and [symbol] (y₂h₂*) where y₁, and y₂ are received signal values from said first and second OFDM carriers respectively, h₁ and h₂ are channel estimates for said first and second OFDM carriers respectively, and * denotes the complex conjugate.

11. A method as claimed in claim 1 wherein said DCM modulated OFDM signal is a UWB signal.

12. A method of decoding a received OFDM signal, the method comprising:
decoding bit log likelihood ratio (LLR) data from a plurality of carriers of said OFDM signal responsive to a received signal strength or signal-to-noise ratio of said received OFDM signal;
determining signal strength or signal-to-noise ratio data for individual carriers or pairs of carriers of said OFDM signal using said LLR data; and
feeding back said signal strength or signal-to-noise ratio data for individual carriers or pairs of carriers of said OFDM signal to said decoding of said bit LLR data to improve said LLR data.

13. A method as claimed in claim 12 wherein said signal strength or signal-to-noise ratio data for individual carriers or pairs of carriers of said OFDM signal comprises data for a signal-to-noise ratio which includes quantisation noise.

14. A method as claimed in claim 12 wherein said received OFDM signal comprises a DCM modulated OFDM signal, and wherein said signal strength or signal-to-noise ratio data for individual carriers or pairs of carriers of said OFDM signal comprises signal-to-noise ratio data determined from a DCM joint carrier pair.

15. A carrier carrying processor control code to implement the method of claim 1.

16. An OFDM DCM decoder for decoding at least one bit value from a DCM OFDM signal, the decoder comprising:
a first input to receive a first signal dependent on a product of a received signal from a first carrier of said DCM OFDM signal and a channel estimate for said first carrier;
a second input to receive a second signal dependent on a product of a received signal from a second carrier of said DCM OFDM signal and a channel estimate for said second carrier;
an arithmetic unit coupled to said first and second inputs and configured to form a plurality of joint distance metric terms including a first pair of joint distance metric terms derived from both said first and second signals and a second pair of joint distance metric terms derived from both said first and second signals, said first pair of joint distance metric terms corresponding to a first binary value of said bit value for decoding, said second pair of joint distance metric terms corresponding to a second binary value of said bit value for decoding;
a first selector coupled to receive said first pair of joint distance metric terms as inputs and to select one of said first pair of joint distance metric terms having a minimum value;
a second selector coupled to receive said second pair of joint distance metric terms as inputs and to select one of said second pair of joint distance metric terms having a minimum value; and
an output coupled to said first and second selectors and configured to output a likelihood value defining a likelihood of said at least one bit value having either said first or said second binary value responsive to a difference between said selected one of said first pair of joint distance metric terms and said selected one of said second pair of joint distance metric terms.

17. An OFDM DCM decoder as claimed in claim 16 further comprising a third input coupled to said arithmetic unit to receive data responsive to a signal level or signal-to-noise ratio of said received signal from said first carrier, and a fourth input coupled to said arithmetic unit to receive data responsive to a signal level or signal-to-noise ratio of said received signal from said second carrier.

18. An OFDM DCM decoder as claimed in claim 16 further comprising a third selector coupled to receive one each of said first and second pairs of joint distance metric terms as inputs and to select one of said input joint distance metric terms having a minimum value, and a fourth selector coupled to receive another each of said first and second pairs of joint distance metric terms as inputs and to select another of said input joint distance metric terms having a minimum value, and a second output coupled to said third and fourth selectors and configured to output a likelihood value defining a likelihood of a second said bit value having either said first or said second binary value responsive to a difference between said selected joint distance metric terms selected by said third and fourth selectors.

19. An OFDM DCM decoder as claimed in claim 16 further comprising a multiplexer coupled to receive inputs from both said first pair and said second pair of joint distance metric terms and configured for control by said likelihood value, said multiplexer having an output to provide a minimum distance metric for a hard decision value of said at least one bit value.

20. An OFDM DCM decoder as claimed in claim 19 further comprising a third selector coupled to receive one each of said first and second pairs of joint distance metric terms as inputs and to select one of said input joint distance metric terms having a minimum value, and a fourth selector coupled to receive another each of said first and second pairs of joint distance metric terms as inputs and to select another of said input joint distance metric terms having a minimum value, and a second output coupled to said third and fourth selectors and configured to output a likelihood value defining a likelihood of a second said bit value having either said first or said second binary value responsive to a difference between said selected joint distance metric terms selected by said third and fourth selectors, wherein said multiplexer is further configured to provide a minimum distance metric term for a hard decision value of said second bit value, the decoder further comprising an SNR calculation unit to determine an SNR for said OFDM signal responsive to SNRs for said received signals from said first and second carriers and to said minimum distance metric terms for said at least one bit value and for said second bit value.

21. A method of decoding an OFDM signal, the method comprising:
inputting a complex received signal value (yᵢ) for a carrier of said OFDM signal;
inputting a complex channel estimate (hᵢ) for said carrier;
determining an intermediate signal value (ρᵢrᵢ) comprising a product of said received signal value and a complex conjugate of said channel estimate (yᵢhᵢ*); and
decoding said UWB OFDM signal using said intermediate signal value.

22. A method as claimed in claim 21 wherein said decoding comprises calculating a log likelihood ratio (LLR) for a data bit represented by said received signal value using said intermediate signal value.

23. A method as claimed in claim 21 in which said received signal value is not divided by said channel estimate to estimate a constellation point.

24. A method as claimed in claim 21 further comprising scaling said intermediate signal value by an estimated noise level.

25. A method as claimed in claim 24 further comprising deriving at least a component of said estimated noise level from an AGC (automatic gain control) loop of a receiver receiving said UWB OFDM signal.

26. A method as claimed in claim 24 wherein said scaling comprises using said estimated noise level as an index to a location in a lookup table; and multiplying said intermediate signal value by a value read from said location in said lookup table.

27. A method as claimed in claim 24 further comprising determining said estimated noise level by summing a first estimated noise component dependent on an estimated thermal noise, and a second noise component comprising a quantisation noise estimate.

28. A method as claimed in claim 22 wherein said OFDM signal comprises a QPSK (Quadrature Phase Shift Keying) modulated OFDM signal, wherein said data bit is represented by a said received signal value modulated onto a plurality of said carriers, and wherein said calculating of said LLR comprises determining a linear sum of a said intermediate signal value for each of said plurality of carriers.

29. A method as claimed in claim 22 wherein said OFDM signal comprises a DCM (dual carrier modulation) modulated OFDM signal, wherein said data bit is represented by a said received signal value modulated onto two different said carriers, and wherein said calculating of said LLR comprises determining a linear sum of a said intermediate signal value for each of said carriers and of a value dependent on a signal level or signal-to-noise ratio of each of said carriers.

30. A method as claimed in claim 21 wherein said OFDM signal comprises a UWB OFDM signal.

31. A carrier carrying processor control code to implement the method of claim 21.

32. An OFDM signal decoder, the decoder comprising:
a first input for a complex received signal value (yᵢ) for a carrier of said OFDM signal;
a second input for a complex channel estimate (hᵢ) for said carrier;
a pre-processor coupled to said first and second inputs to determine and output an intermediate signal value (ρᵢrᵢ) comprising a product of said received signal value and a complex conjugate of said channel estimate (yᵢhᵢ*); and
a decoder coupled to an output of said pre-processor to decode said UWB OFDM signal using said intermediate signal value.

33. A method of decoding an OFDM signal in a digital receiver system, the method comprising:
inputting a complex received signal value (yᵢ) for a carrier of said OFDM signal, said received signal value being derived from analogue-to-digital conversion of a received signal;
inputting first and second components of estimated noise for said received signal value, one of said components of estimated noise representing quantisation noise from said analogue-to-digital conversion;
summing said first and second estimated noise components to determine a combined estimated noise for said received signal data; and
determining likelihood data for a data bit represented by said received signal value wherein said likelihood data is dependent on said combined estimated noise.

34. A decoder for determining a bit log likelihood ratio, LLR for a DCM (dual carrier modulation) modulated OFDM signal, the decoder comprising a system to calculate a value for
$$LLR ( {b}_{n} ) = {min}_{{x}_{j} ∈ S0} ( {ρ}_{1} {‖ {r}_{1} - {x}_{j}^{1} ‖}^{2} + {ρ}_{2} {‖ {r}_{2} - {x}_{j}^{2} ‖}^{2} ) - {min}_{{x}_{i} ∈ S1} ( {ρ}_{1} {‖ {r}_{1} - {x}_{i}^{1} ‖}^{2} + {ρ}_{2} {‖ {r}_{2} - {x}_{i}^{2} ‖}^{2} )$$
where xⱼεS0 represents a set of DCM constellation points for which bₙ has a first binary value and xᵢεS1 represents a set of DCM constellation points for which bₙ has a second, different binary value; xⱼ¹ and xⱼ² and xᵢ¹ and xᵢ² represent constellation points for xⱼ and xᵢ in different first and second constellations of said DCM modulation respectively, the superscripts labelling constellations; ρ₁ and ρ₂ representing signal levels or signal-to-noise ratios of first and second OFDM carriers modulated using said first and second constellations respectively; r₁ and r₂ representing equalised received signal values from said first and second OFDM carriers respectively, and min ( ) representing determining a minimum value; and ∥·∥ representing a distance metric.
